(19) United States
(12) Patent Application Publication
(10) Pub. No.: US 2017/0017190 A1
(43) Pub. Date: Jan. 19, 2017

(54) IMAGE FORMING APPARATUS

(71) Applicants: HIDEHIKO MAEDA, Tokyo (JP); Tetsuji Nishikawa, Kanagawa (JP); Kohta Takenaka, Kanagawa (JP); Hiroshi Ishii, Kanagawa (JP); Kouta Hirakawa, Tokyo (JP); Gaku Hosono, Kanagawa (JP); Shogo Terakawa, Kanagawa (JP)

(72) Inventors: HIDEHIKO MAEDA, Tokyo (JP); Tetsuji Nishikawa, Kanagawa (JP); Kohta Takenaka, Kanagawa (JP); Hiroshi Ishii, Kanagawa (JP); Kouta Hirakawa, Tokyo (JP); Gaku Hosono, Kanagawa (JP); Shogo Terakawa, Kanagawa (JP)

(73) Assignee: Ricoh Company, Ltd., Tokyo (JP)

(21) Appl. No.: 15/201,823

(22) Filed: Jul. 5, 2016

(30) Foreign Application Priority Data
Jul. 16, 2015 (JP) 2015-142101

(51) Int. Cl. G03G 15/00

(52) U.S. Cl. CPC G03G 15/70

(57) ABSTRACT

An image forming apparatus includes a body; an openably closable drawer unit including an image forming section to form an image on a recording medium; and a circuit board. The circuit board is disposed in a substantial center of the drawer unit in a direction in which the drawer unit is pulled out of the body.

### CROSS-REFERENCE TO RELATED APPLICATION

The present application claims priority pursuant to 35 U.S.C. §119(a) from Japanese patent application number 2015-142101, filed on Jul. 16, 2015, the entire disclosure of which is incorporated by reference herein.

### BACKGROUND

Technical Field

Exemplary embodiments of the present invention relate to an image forming apparatus including a drawer unit.

Background Art

An image forming apparatus including a drawer unit that continues to operate even when the drawer is pulled out from the apparatus and is opened is known. Such a drawer unit including various units is incorporated in the image forming apparatus, so that various functions are enabled, including paper jam handling via an LED, control of motors and fans, etc., to thereby improve performance of the image forming apparatus.

### SUMMARY

In one embodiment of the disclosure, provided is an improved image forming apparatus including a body; an openably closable drawer unit including an image forming section to form an image on a recording medium; and a circuit board. The circuit board is disposed in a substantial center of the drawer unit in a direction in which the drawer unit is pulled out of the body.

These and other features and advantages of the present invention will become apparent upon consideration of the following description of the preferred embodiments of the present invention when taken in conjunction with the accompanying drawings.

### BRIEF DESCRIPTION OF THE DRAWINGS

The aforementioned and other aspects, features, and advantages of the present disclosure would be better understood by reference to the following detailed description when considered in connection with the accompanying drawings, wherein:

FIG. 1 schematically illustrates an exemplary image forming apparatus according to an embodiment of the present invention;

FIG. 2 is a cross-sectional view of the image forming apparatus in a state in which a drawer unit is pulled out and is opened;

FIG. 3 schematically illustrates a disposition of each part in the drawer unit according to an embodiment of the present invention;

FIG. 4 schematically illustrates a disposition of each part in the drawer unit according to a comparative example;

FIG. 5 illustrates a disposition of a circuit board disposed inside a body of the image forming apparatus according to the embodiment of the present invention;

FIG. 6 illustrates a disposition of the circuit board disposed inside the image forming apparatus according to a comparative example;

FIG. 7 is a conceptual view illustrating accessibility of the circuit board, in which a positional relation of a transfer belt unit and the circuit board between the transfer section and a fixing unit; and

FIG. 8 is a conceptual view illustrating accessibility of the circuit board, in which an extracted state of the transfer belt unit is shown.

### DETAILED DESCRIPTION

Hereinafter, embodiments of the present invention will be described in which a drawer unit of the image forming apparatus includes a circuit board disposed between a transfer section and a reverse conveyance section of the drawer unit.

An image forming apparatus including a reverse conveyance conduit in general includes a narrow vertical space at lateral ends of the conveyance conduit. In addition, because a fixing unit installed therein is tall compared to other units disposed inside the drawer unit, there is a large vertical space between the transfer section and the reverse conveyance section. Accordingly, by disposing the circuit board between the transfer section and the reverse conveyance section, dead space can be minimized. Because the circuit board including a control function of a conveyance drive motor takes a space inside the apparatus, the above disposition of the circuit board contributes greatly to make the apparatus more compact. Positioning the circuit board in a center of the apparatus also serves to shorten a length of the wire harness relative to each electronic part and the harnesses are distributed dispersedly from the center. As a result, the harness bundle can be smaller, to thereby make the apparatus smaller. Further, eccentricity of the center of gravity can be reduced. Furthermore, because the circuit board is disposed at a bottom of a conveyance belt unit and the conveyance belt unit can be retracted, connection of the harnesses to the circuit board can be improved.

The image forming apparatus according to the embodiment of the present invention will be described in detail referring to accompanied drawings.

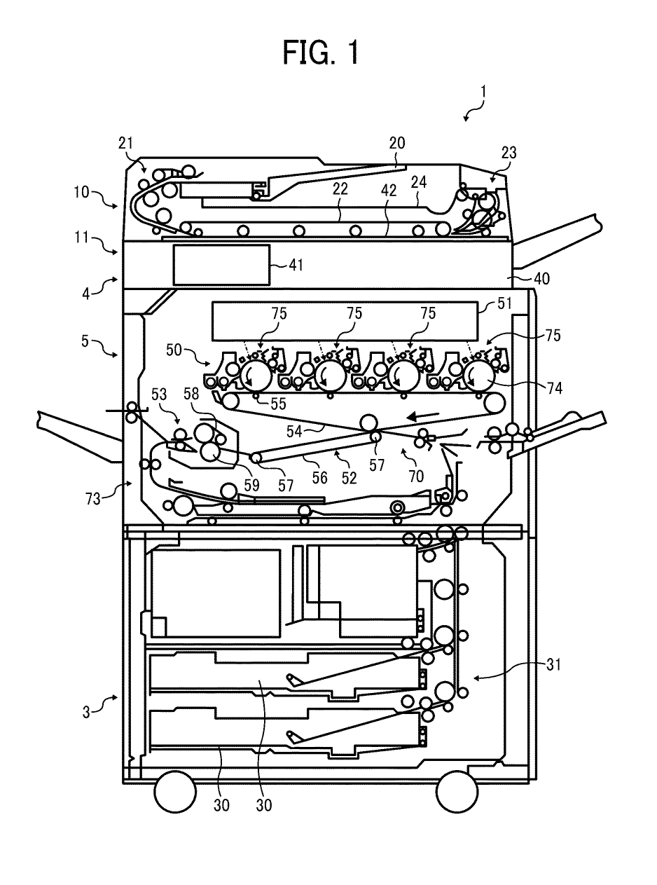

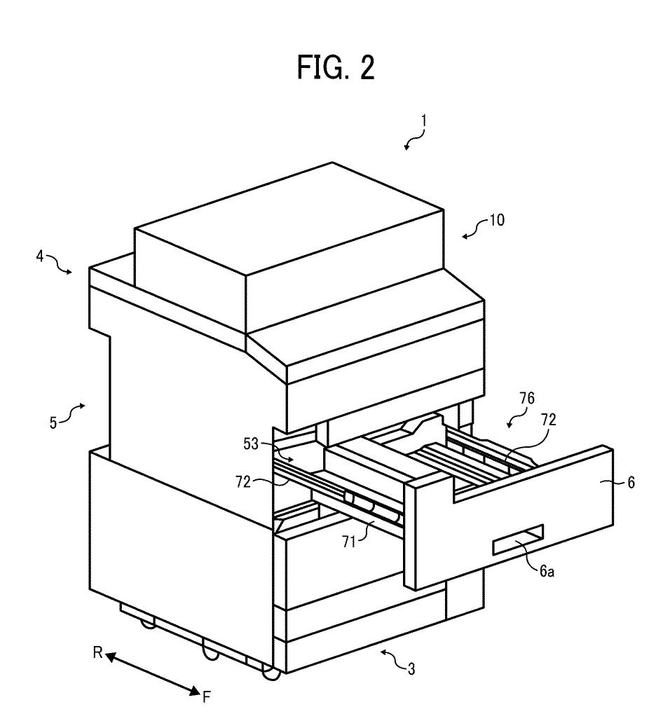

FIG. 1 schematically illustrates an exemplary image forming apparatus according to an embodiment of the present invention. FIG. 2 is a cross-sectional view of the image forming apparatus in a state in which the drawer unit is pulled out. As illustrated in FIG. 1, the image forming apparatus 1 includes an automatic document feeder (hereinafter referred to as an ADF) 10, and a body 11 of the image forming apparatus. In addition, the body 11 includes a sheet feeder section 3, an image reader section 4, and an image forming section 5. At a front side F of the image forming section 5, a front cover 6 is disposed at a front face of a drawer unit 76, which is described later below. As illustrated in FIG. 2, the front side F of the image forming apparatus 1 denotes a near side of the image forming apparatus and a rear side R denotes a back side of the image forming apparatus 1.

The ADF 10 includes a document tray 20, sheet feed rollers 21, a conveyance belt 22, a sheet ejection roller 23, and a sheet ejection tray 24. The ADF 10 is so disposed as to be openably closable relative to the image reader section 4 via an open/close mechanism such as a hinge.

The sheet feed roller 21 separates each sheet from a bundle of documents placed on the document tray 20 one after another, and conveys each sheet to the image reader section 4. The conveyance belt 22 conveys the document separated by the sheet feed roller 21 to the image reader section 4. The sheet ejection roller 23 ejects the document conveyed by the conveyance belt 22 from the image reader section 4, to the sheet ejection tray 24 disposed below the document tray 20. The sheet feed section 3 includes sheet cassettes 30 and a sheet feeder 31. Each of the sheet cassettes 30 includes a plurality of recording media with a different size. The sheet feeder 31 conveys the recording media stored in the sheet cassette 30 to an image forming position of the image forming section 5.

The image reader section 4 includes a housing 40, an optical scanning unit 41, a contact glass 42, and a driver. The optical scanning unit 41 disposed inside the housing 40 includes an LED unit. The LED unit of the optical scanning unit 41 emits light beams in a main scanning direction, and the driver scans an entire area of the emitted light beams in a sub scanning direction. With this structure, the optical scanning unit 41 reads two-dimensional color images of the document.

The contact glass 42 disposed at an upper part of the housing 40 of the image reader section 4 constructs an upper part of the housing 40. The driver includes wire harnesses secured to the optical scanning unit 41, a plurality of driven and drive pulleys bridged to the wire harnesses, and a motor to rotate the drive pulleys.

The image forming section 5 includes an exposure unit 51, a tandem image forming device 50, an intermediate transfer belt 54, an intermediate transfer roller 55, a secondary transfer device 52, a fixing unit 53 as an example of a fixing device, a main conveyance conduit 70, and a reverse conveyance conduit 73. As illustrated in FIG. 1, the exposure unit 51 is disposed adjacent to the tandem image forming device 50 and performs optical exposure onto each photoconductor drum 74 disposed to handle each color of image formation.

The tandem image forming device 50 is disposed above an intermediate transfer belt 54 and includes four image forming units 75, each of which handles a color of yellow, cyan, magenta, or black, and is disposed along a rotational direction of the intermediate transfer belt 54. Detailed explanation of each of the image forming unit 75 is omitted; however, around each of the photoconductor drum 74 for each color, a developing device, a photoconductor cleaner, and an electrical discharger are respectively disposed. Those devices disposed around each of the photoconductor drums 74 and the photoconductor drum 74 are integrated into a unit, to thereby construct a process cartridge. In the tandem image forming device 50, based on image information read and color-decomposed by the image reader section 4, a visible image or a toner image formed with color toner is generated on each of the photoconductor drums 74. The visible image formed on each of the photoconductor drums 74 is transferred to the intermediate transfer belt 54 between each of the photoconductor drums 74 and the intermediate transfer roller 55.

On the other hand, a secondary transfer device 52 is disposed opposite the tandem image forming device 50 with the intermediate transfer belt 54 sandwiched in between. The secondary transfer device 52 is configured such that an endless secondary transfer belt 56 is stretched around two support rollers 57. Then, the secondary transfer belt 56 is pressed against the intermediate transfer belt 54, and the toner image formed on the intermediate transfer belt 54 is transferred to a recording medium that has been conveyed via the main conveyance conduit 70 from the sheet feeder section 3. It is noted that the secondary transfer device 52 may be formed of a secondary transfer roller instead of the secondary transfer belt 56.

A fixing unit 53 is disposed downstream of the secondary transfer device 52 in the conveyance direction of the recording medium. The fixing unit 53 is configured such that a pressure roller 59 is pressed against an endless fixing belt 58. The fixing unit 53 applies heat and pressure to the recording medium via the pressure roller 59 so that the toner of the toner image transferred to the recording medium is fused. As a result, the toner image is fixed onto the recording medium as a color image.

As illustrated in FIG. 1, the reverse conveyance conduit 73 is disposed below the secondary transfer device 52 and the fixing unit 53. The reverse conveyance conduit 73 reverses the recording medium discharged from the fixing unit 53 upside down, and supplies it again to the secondary transfer device 52 via the main conveyance conduit 70, so that the color image is formed on both sides of the recording medium.

As illustrated in FIG. 2, the front cover 6 is disposed on the front side of a carrier 71. The carrier 71 moves forwards and backwards while supported by rails 72 relative to the image forming section 5, as indicated by arrow FR in FIG. 2. In addition, the secondary transfer device 52, the fixing unit 53, the main conveyance conduit 70, and the reverse conveyance conduit 73 are mounted to the carrier 71. Those devices including the carrier 71, the secondary transfer device 52, the fixing unit 53, the main conveyance conduit 70, and the reverse conveyance conduit 73 construct a drawer unit 76. Specifically, the front cover 6 is formed together with the drawer unit 76 as a unit, so that the front cover 6 can be moved forwards or backwards relative to the image forming section 5 by opening a convex pullout handle 6a disposed on the front cover 6 and then sliding down the front cover 6 backwards. With this movement, the drawer unit 76 can be opened and closed.

As described above, the secondary transfer device 52, the fixing unit 53, the main conveyance conduit 70, and the reverse conveyance conduit 73 are movable forwards and backwards relative to the image forming section 5 while being held by the carrier 71. These devices are stored in the image forming section 5 during operation of the image forming apparatus 1. On the other hand, in replacement of each device or removing the recording medium jammed inside the image forming section 5, the replacement of various parts and removal of the recording medium can be performed by pulling out the carrier 71 toward the front side F of the image forming section 5.

The image forming apparatus 1 includes the body 11 that includes the image forming section 5 to form images on the recording medium and the sheet feeder section 3 to supply recording media to the image forming section 5. In the embodiments of the present invention, the image forming apparatus 1 further includes the drawer unit 76 including a part of the devices that forms the image forming section 5 and configured to be opened and slid down to the body 11 of the image forming apparatus 1. The image forming apparatus 1 further includes wire harnesses to electrically connect the body 11 of the image forming apparatus, a holder member to hold the wire harnesses, and an indicator disposed on the drawer unit 76, to indicate a portion which jam handling is required. The drawer unit 76 according to the present embodiment at least includes the fixing unit 53 and the reverse conveyance conduit 73.

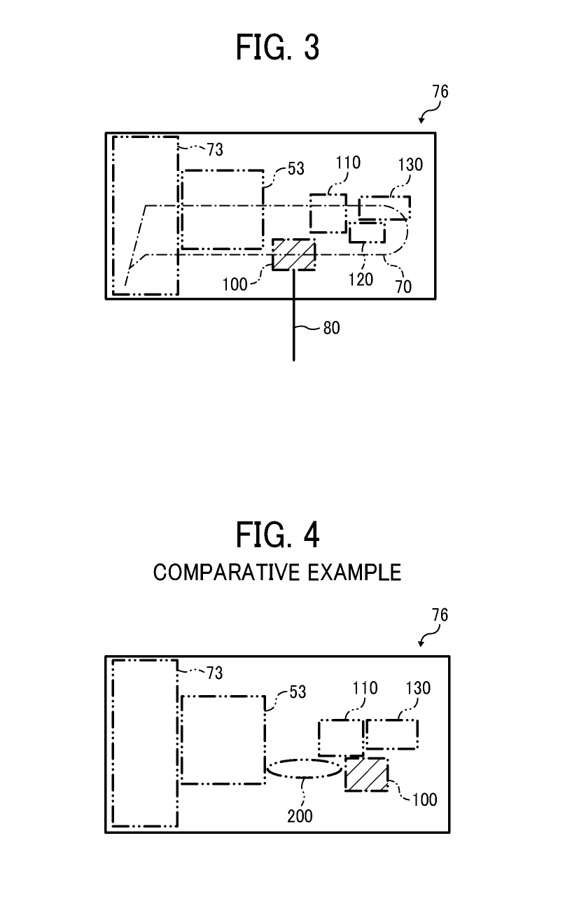

FIGS. 3 and 4 schematically illustrate a disposition of each part in the drawer unit, in which FIG. 3 illustrates the drawer unit according to an embodiment of the present invention and FIG. 4 illustrates the drawer unit according to a comparative example. A circuit board 100 may be large in size due to a controlling function in the case of paper jam handling guidance and a controlling function of the drive motor such as a control on the conveyance of the recording medium. As illustrated in FIG. 3, the circuit board 100 is disposed at a substantial center between the transfer section 110 and the reverse conveyance conduit 73. With this structure, the apparatus can be made more compact. Further, the transfer section 110 includes the secondary transfer device 52 as illustrated in FIG. 1. Furthermore, the circuit board 100 is provided with a power cable 80 (see FIG. 3), such as a curl cord, as an energizing device to supply power to the drawer unit 76 even when the drawer unit is pulled out to be opened. One end of the power cable 80 is connected to the circuit board 100 and the other end thereof is connected to the body of the image forming apparatus, the drawer unit 76, or a unit inside the drawer unit 76.

For example, in a space inside the conveyance conduit of the image forming apparatus including the reverse conveyance conduit as illustrated in FIG. 4, because the fixing unit 53 is tall compared to other units disposed inside the drawer unit 76, there is a large dead space 200 extending vertically between the transfer section 110 and the reverse conveyance conduit 73. As a result, with the structure as illustrated in FIG. 3, the dead space can be effectively used and the entire apparatus can be made more compact. The dead space also extends below the transfer section 110. Accordingly, by providing a contact/separation mechanism 120 of the transfer section 110 in the dead space as illustrated in FIG. 3, the transfer section 110 is left in a separated state from driving device during image formation, thereby preventing the rollers in the transfer section 110 from being contaminated. Reference numeral 130 in FIG. 3 or 4 denotes a registration section including a registration roller pair and the driving device thereof.

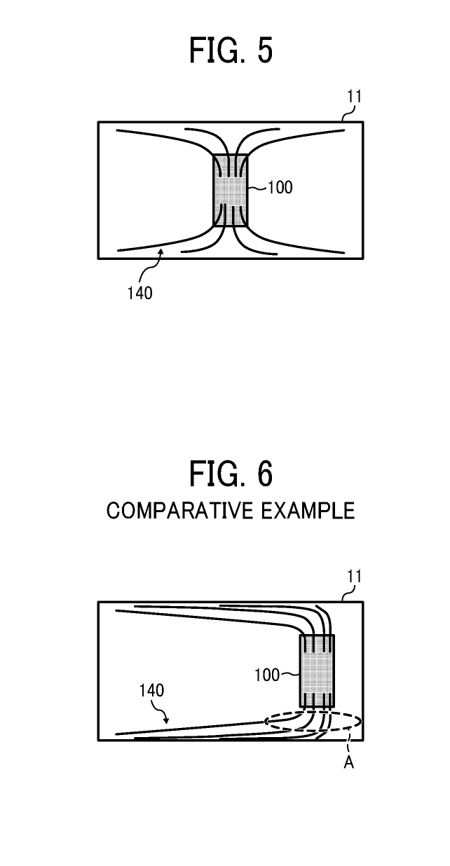

FIGS. 5 and 6 illustrate a disposition of the wire harness 140 depending on the disposition of the circuit board 100 inside the body 11 of the image forming apparatus, in which FIG. 5 relates to the embodiment of the present invention and FIG. 6 illustrates a disposition of the same according to a comparative example.

As illustrated in FIG. 5 according to the present embodiment, the circuit board 100 positions at the substantial center of the body 11 of the image forming apparatus, thereby enabling to shorten a length of the wire harness 140 to energize each electronic part. In addition, because the wire harness 140 extends from the center dispersedly, compared to the comparative example as illustrated in FIG. 6, the bundle of the harnesses can be smaller, to thereby make the entire apparatus smaller. A numeral ‘A’ in FIG. 6 illustrates that the bundle of the harnesses is large.

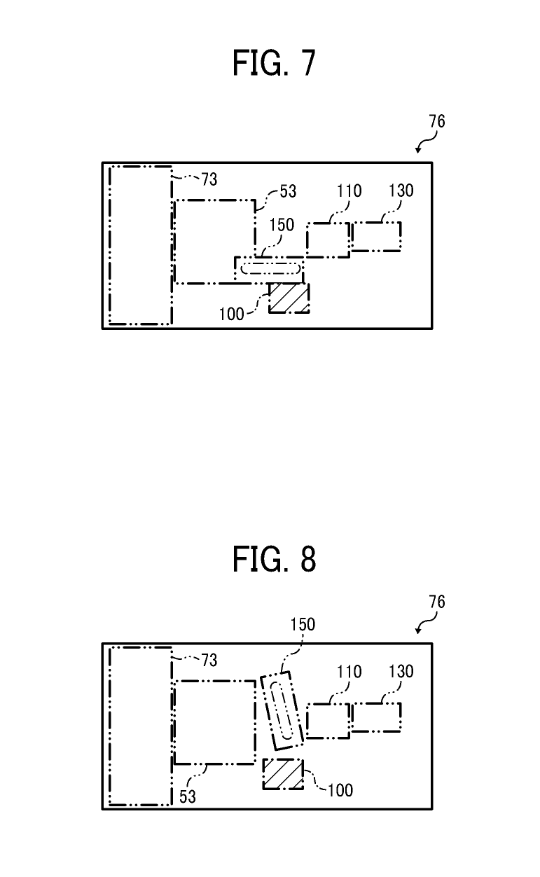

FIGS. 7 and 8 schematically illustrate accessibility of the circuit board 100, in which FIG. 7 illustrates a positional relation of the conveyance belt unit 150 and the circuit board 100 between the transfer section 110 and the fixing unit 53, and FIG. 8 illustrates a retracted state of the conveyance belt unit 150.

As illustrated in FIG. 7, the circuit board 100 is disposed below the conveyance belt unit 150. By retracting the conveyance belt unit 150 as illustrated in FIG. 8, the circuit board 100 is accessed easily by the other devices. Specifically, because the conveyance belt unit 150 is rotatably disposed, the conveyance belt unit is accessed by the circuit board 100 easily even disposed above the circuit board 100. As a result, even when the circuit board 100 fails, repair time the circuit board 100 can be reduced.

As described in the above embodiments, according to at least one embodiment of the present invention, by providing the circuit board at a position between the transfer section and the reverse conveyance conduit, the dead space can be reduced and the image forming apparatus can be more compact.

Additional modifications and variations of the present invention are possible in light of the above teachings. It is therefore to be understood that, within the scope of the appended claims, the invention may be practiced other than as specifically described herein.

What is claimed is:

1. An image forming apparatus comprising:
a body;
an openably closable drawer unit including an image forming section to form an image on a recording medium; and
a circuit board,
wherein the circuit board is disposed in a substantial center of the drawer unit in a direction in which the drawer unit is pulled out of the body.

2. The image forming apparatus according to claim 1, wherein the drawer unit further comprises:
a fixing device;
a reverse conveyance conduit;
a registration unit; and
a transfer section.

3. The image forming apparatus according to claim 2, wherein the circuit board is disposed between the transfer section and the reverse conveyance conduit.

4. The image forming apparatus according to claim 3, further comprising a conveyance belt disposed at an upper part of the circuit board, to convey the recording medium from the transfer section to the fixing device.

5. The image forming apparatus according to claim 1, wherein the drawer unit comprises only one circuit board.

6. The image forming apparatus according to claim 1, wherein the circuit board includes a control circuit that provides paper jam handling guidance and controls conveyance of the recording medium.

7. The image forming apparatus according to claim 1, further comprising an energizing device to supply power to electronic devices inside the drawer unit with the drawer unit opened.
